(19) United States
(12) Patent Application Publication
(10) Pub. No.: US 2014/0069546 A1
(43) Pub. Date: Mar. 13, 2014

(54) FIRE RETARDANT AND ANTI STATIC PIPE

(71) Applicant: John McNab, Hornsby (AU)

(72) Inventor: John McNab, Hornsby (AU)

(73) Assignee: PIPELION PTY LTD, Hornsby, New South Wales (AU)

(21) Appl. No.: 14/115,132

(22) PCT Filed: Apr. 30, 2012
(86) PCT No.: PCT/AU2012/000453

§ 371 Date: Nov. 1, 2013

(30) Foreign Application Priority Data
May 5, 2011 (AU) 2011901669

(51) Int. Cl. F16L 9/133; B29D 23/00

(52) U.S. Cl. CPC F16L 9/133; B29D 23/001
USPC 138/140; 264/173.11

(57) ABSTRACT

A pipe is described having a wall defining a bore, the wall is formed from at least two layers comprising: a structural core layer; an outer layer which is statically dissipative; and wherein the outer layer is also fire retardant.

### TECHNICAL FIELD

The present invention relates to pipe systems and particularly relates to pipes with fire retardant and anti-static properties.

### BACKGROUND TO THE INVENTION

Pipes are well known for use in conveying fluids under pressure such as water, other liquids, or compressed air.

In certain environments, such as in underground mines, for example, there is a particular need for pipes to have either or both of fire retardant or anti-static properties for safety reasons. One suitable material for this purpose is steel. However, steel pipe installations are expensive to manufacture and install. Furthermore, steel is prone to corrosion and thus has a limited life span, requiring replacement of the entire pipe installation.

### SUMMARY OF THE INVENTION

In a first aspect the present invention provides a pipe having a wall defining a bore, the wall is formed from at least two layers comprising: a structural core layer; an outer layer which is statically dissipative; and wherein the outer layer is fire retardant.

The outer layer may include a statically dissipative polymer.

The statically dissipative polymer may be in the form of a matrix distributed in a host polymer.

The host polymer may include polypropylene.

The structural core layer may be formed from a polymer such as polypropylene.

The outer layer may include a non-halogenated fire retardant material.

The pipe may further include an inner layer which is also statically dissipative.

In a second aspect the present invention provides a method of producing a pipe including the steps of: co-extruding at least two pipe layers comprising: a structural core layer; and an outer layer which is statically dissipative and fire retardant.

The outer layer may be formed by distributing a statically dissipative polymer as a matrix into a host polymer.

The host polymer may include polypropylene.

The outer layer may be made fire retardant by the addition of a non-halogenated fire retardant material.

The method may further include the step of co-extruding an inner layer which is statically dissipative.

The inner layer may be formed by distributing a statically dissipative polymer as a matrix into a host polymer.

The inner layer may be made fire retardant by the addition of a non-halogenated fire retardant material.

### BRIEF DESCRIPTION OF THE DRAWINGS

An embodiment of the present invention will now be described, by way of example only, with reference to the accompanying drawings, in which:

FIG. 1 is a perspective view of a section of pipe according to an embodiment of the invention; and

FIG. 2 is an end view of the pipe of FIG. 1.

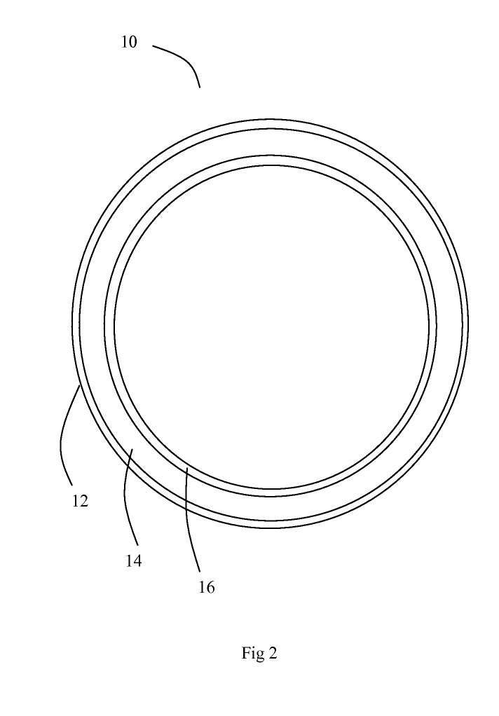

### DETAILED DESCRIPTION OF THE PREFERRED EMBODIMENT

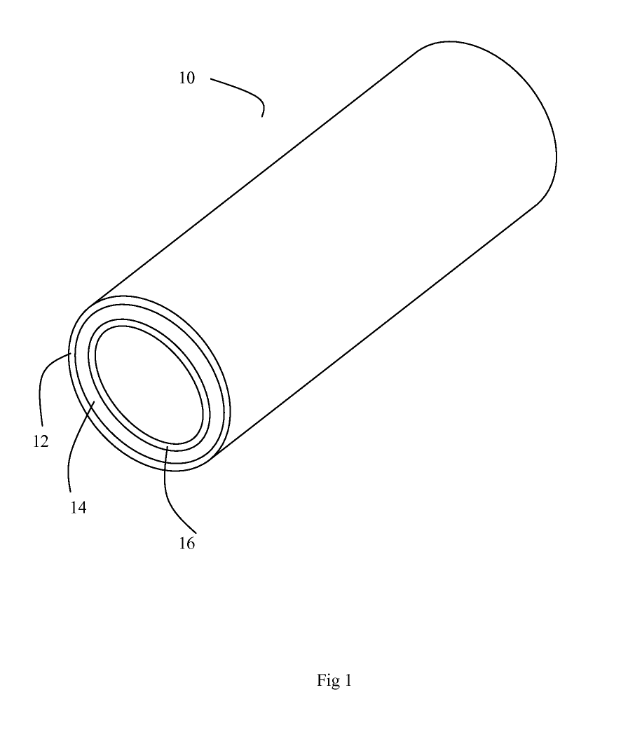

Referring to FIG. 1, a length of pipe 10 is shown in perspective view. The pipe has been formed by a co-extrusion process and has a multi-layered wall structure which defines a central bore.

Outer layer 12 consists of a statically dissipative outer layer which is formed by distributing a statically dissipative polymer in a polypropylene-based host polymer which has also been mixed with a non-halogenated fire retardant material.

Inner layer 16 is formed from the same material as layer 12. In some embodiments, the fire retardant material is omitted from layer 16.

Intermediate structural core layer 14 is formed from Impact Modified Copolymer Polypropylene. Layer 14 has high strength and provides the overall multilayer pipe structure with strength making it suitable for use in pressure or vacuum applications.

Statically dissipative polymers are commercially available and are used, for instance, in the production of electrostatically discharging packaging for use in the electronics industry.

In other embodiment the inner and outer layers may be made statically dissipative by the addition of one or more of carbon black, carbon nanotubes or metal fibres.

Where a layer is said to be statically dissipative it is generally considered by those skilled in the art to have a level of resistivity between 10⁵ and 10¹¹ ohm-metres. This provides a suitable level of electrical conductivity to dissipate charge in a reasonably short time without the risk of a spark hazard and avoids the need to provide earthing for a pipe installation formed using pipe according to embodiments of the invention.

Non-halogenated fire retardant materials are commercially available and can include one or more of ammonium polyphosphate (APP), melamine polyphosphate (MPP), magnesium hydroxide, aluminium trihydrate and red phosphorous.

Where a layer is said to be fire retardant it is generally understood by those skilled in the art that it would meet one of the classifications under the UL 94 standard, which is a plastics flammability standard released by Underwriters Laboratories of the USA.

Pipe 10 is formed in a continuous co-extrusion process in which all three layers are combined in one operation. The constituents of each of the layers are heated and mixed appropriately and introduced into an extrusion machine fitted with a co-extrusion die. Lengths of pipe emanating from the machine are cut to desired lengths and allowed to cool.

In the embodiments described above, the fire retardant material used was a non-halogenated fire retardant material. In other embodiments, a halogen based fire retardant material may be used such as a bromide or chloride.

In the embodiment described above the inner and outer layers included a polypropylene host polymer. Similarly, other host polymers could be used such as other polyolefins including polyethylene or polybutylene.

It can be seen that embodiments of the invention provide at least one of the following advantages:
Pipe is suitable for use in areas where fire rating and anti-static rating is required.
Being non-metallic, pipe does not suffer from corrosion.
Being polymeric, pipe is lightweight and simple to transport and cut to length
Non-halogenated fire retardant provides improved safety over bromide based fire retardant in the event of fire
Pipe is suitable for pressure and vacuum applications
No earthing required

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1-18. (canceled)

19. A pipe having a wall defining a bore, the wall is formed from at least two layers comprising:
a structural core layer;
an outer layer which is statically dissipative;
wherein the outer layer is fire retardant; and
wherein the outer layer includes a statically dissipative polymer distributed as a matrix in a host polymer.

20. The pipe according to claim 19 wherein the host polymer includes polypropylene.

21. The pipe according to claim 19 wherein the structural core layer is formed from a polymer.

22. The pipe according to claim 21 wherein the polymer of the structural core layer includes polypropylene.

23. The pipe according to claim 19 wherein the outer layer includes a non-halogenated fire retardant material.

24. The pipe according to claim 19 further including an inner layer which is also statically dissipative.

25. The pipe according to claim 24 wherein the inner layer includes a statically dissipative polymer.

26. The pipe according to claim 25 wherein the statically dissipative polymer of the inner layer is distributed as a matrix in a host polymer.

27. The pipe according to claim 26 wherein the host polymer of the inner layer includes polypropylene.

28. A method of producing a pipe including the steps of:
co-extruding at least two pipe layers comprising:
a structural core layer; and
an outer layer which is statically dissipative and fire retardant; and
wherein the outer layer is formed by distributing a statically dissipative polymer as a
matrix into a host polymer.

29. The method according to claim 28 wherein the host polymer includes polypropylene.

30. The method according to claim 28 wherein the outer layer is made fire retardant by the addition of a non-halogenated fire retardant material.

31. The method according to claim 28 wherein the structural core layer is formed from polypropylene.

32. The method according to claim 28 further including the step of co-extruding an inner layer which is statically dissipative.

33. The method according to claim 32 wherein the inner layer is formed by distributing a statically dissipative polymer as a matrix into a host polymer.

34. The method according to claim 33 wherein the host polymer of the inner layer includes polypropylene.

35. The method according to claim 32 wherein the inner layer is also fire retardant.

36. The method according to claim 35 wherein the inner layer is made fire retardant by the addition of a non-halogenated fire retardant material.
